(19) United States
(12) Patent Application Publication
(10) Pub. No.: US 2010/0072743 A1
(43) Pub. Date: Mar. 25, 2010

(54) PUSH FIT COUPLING

(75) Inventors: Janos KERTESZ, Sulzbach (DE); Gerhard WACHTER, Buedingen (DE)

Correspondence Address: GREENBLUM & BERNSTEIN, P.L.C., 1950 ROLAND CLARKE PLACE, RESTON, VA, 20191, US

(73) Assignee: NORMA GERMANY GMBH, Maintal (DE)

(21) Appl. No.: 12/557,718

(22) Filed: Sep. 11, 2009

(30) Foreign Application Priority Data
Sep. 19, 2008 (DE) 10 2008 048 040.1

(51) Int. Cl. F16L 55/00

(52) U.S. Cl. 285/24

(57) ABSTRACT

Push fit coupling and method for connecting two elements with a push fit coupling. The push fit coupling includes a first element having a plug-in opening, a second element insertable into the plug-in opening, a retaining device surrounding at least one of the first and second elements; and at least one seal located on an inside of the retaining device. The first and second elements have front face sections facing towards one another, and the at least one seal is arranged between the front face sections.

### CROSS-REFERENCE TO RELATED APPLICATIONS

The present application claims priority under 35 U.S.C. §119 of German Patent Application No. 10 2008 048 040.1, filed on Sep. 19, 2008, the disclosure of which is expressly incorporated by reference herein in its entirety.

### BACKGROUND OF THE INVENTION

1. Field of the Invention

The invention relates to a push fit coupling with a first element, which has a plug-in opening, a second element, which can be inserted into the plug-in opening, a retaining device that surrounds at least one of these two elements, and at least one seal.

2. Discussion of Background Information

A push fit coupling of the type generally described above is known, for example, from DE 37 27 858 C2. Two hose lines or pipelines can be connected to one another with a push fit coupling of this type. The first element is arranged at the end of a first line and the second element is arranged at the end of a second line. The connection is then simply produced by inserting the second element into the first element.

The seal is intended to ensure that the fluid flowing in the assembled line cannot reach the outside. The seal must therefore be dimensioned accordingly, in particular, when the fluid is under a higher pressure. In the known case, the seal is formed by two toroidal sealing rings, which are arranged in grooves on the circumference of the second element. This means that a relatively high fitting force must be exerted when the two elements are connected. This fitting force is then used mainly to overcome the frictional force between the seal and the inside of the first element.

### SUMMARY OF THE INVENTION

The invention achieves a good seal with low fitting forces.

According to the invention, a push fit coupling of the type generally discussed above includes a seal is arranged inside on a retaining device, a first element and a second element having front face sections respectively facing towards one another. The seal is arranged between the front face sections.

In embodiments, the seal tightness is generated by the seal through interaction of the seal interacts with the two front face sections. Accordingly, the frictional forces that arise during the assembly of the two elements can be kept small. It is namely not necessary for the seal to be arranged between the two elements with a corresponding preloading in the radial direction. The fact that the seal is arranged inside on the retaining device provides the additional advantage that the seal has a certain protection when both elements are not assembled. Although damage by an accidental incorrect impingement from outside is not ruled out, it is relatively unlikely however due to the arrangement of the seal inside the retaining element.

Preferably, the seal in section has two legs, each of which bears against a front face section. The two legs accordingly have on their free end a certain spacing from one another in the fitting direction. Thus, they form a cavity into which the fluid can penetrate when the second element is inserted into the first element. The pressure of the fluid then ensures that the legs are pressed against the front faces assigned thereto. The greater the pressure of the fluid, the greater the pressure with which the legs are respectively pressed against their front face sections, so that the seal tightness increases with increasing pressure inside the elements. Tests have shown that a seal in accordance with embodiments of the invention is definitely tight up to a pressure of 36 bar. Furthermore, the legs have the advantage that the forces that are necessary for assembly can be kept low, even when the front face sections come to rest against the seal and may have to deform it somewhat. A leg that is held only at one end can be deformed relatively easily.

Preferably, the leg that bears against the front face section of the first element forms a leak path with a circumferential area of the second element. If a leak path is provided, it is ensured that fluid can penetrate from the interior of the two elements into the area between the legs, in order to press the legs against the corresponding front face sections. Furthermore, when a leak path is provided, the frictional forces between the seal and the second element can be kept low.

Preferably, the two legs form a leak path with the circumferential area of the second element. The advantage of this is that the seal can be embodied symmetrically in the axial direction, which facilitates production. Furthermore, the insertion direction of the two elements is then no longer very important.

Preferably, the legs maintain a predetermined spacing from the circumferential area with their radial insides. It is therefore deliberately provided that the seal does not touch the circumferential area of the second element. This avoids the development of frictional forces between the seal and the second element during insertion. Thus, on the one hand, the fitting forces are kept low and, on the other hand, the risk is also low that the seal will be damaged during insertion of the second element into the first element. Furthermore, due to the spacing, the risk is kept low of the seal sticking to the circumferential area of the second element, which would render disassembly more difficult.

It is also advantageous if at least one leg has an outside facing towards its front face section with a shape that corresponds to the shape of the front face section. However, it does not need to be an identical match in this case, i.e., an approximation of the shape of the front face section and the shape of the leg is sufficient. This ensures that the leg no longer needs to be greatly deformed in order to bear flat against its front face section. A sufficient seal tightness is thus achieved even with low pressures.

Preferably, at least one leg has an essentially constant thickness. This leg is then essentially uniformly deformable over its entire length through the pressure that prevails in the area between the two legs. Accordingly, it can be ensured that it also bears uniformly against the corresponding front face section over its length. The greater the length, i.e., the sealing length, the better the seal tightness.

Preferably, the two legs start from a common base area. This produces as it were a common pivot point for both legs about which the legs can be pivoted. This is an advantage when a small clearance is to be left during the insertion of the two elements.

Preferably, at least one leg is curved. Accordingly, the front face section assigned to this leg is also curved. In embodiments, the seal therefore has the shape of a section of a torus. Accordingly, by applying pressure in the area between the two legs, it can be ensured that a flat bearing of the outside of the leg on the front face section assigned thereto results. Alternatively thereto, the two legs can also be arranged in a V-shaped manner with respect to one another or in the manner of a trapezoid.

Preferably, the retaining device is embodied or formed separately from the first element and from the second element. Thus, the retaining device can form a third element. For example, the retaining device can be provided with structures or elements to engage with the two elements in order to guarantee an axial holding of the two elements. Moreover, if the retaining device is embodied as a separate element, there are extensive possibilities for also producing the seal independently of each of the two elements.

The seal is preferably connected to the retaining device in a fluidically sealed manner. When it is connected in a fluidically sealed manner it can be adhered, fused or welded. It can also be cast jointly with the retaining element. In embodiments, it is embodied or formed in one piece with the retaining element.

Alternatively thereto, the seal can also be connected to the retaining element in a positive manner. In this case, the retaining device can have a groove, for example, into which the seal is inserted or placed.

Preferably, the seal has a sealing foot, which surrounds the first element and the second element. The sealing foot has two functions, i.e., it is used to hold the seal onto the retaining element, and it forms a guide for the two elements during insertion.

Preferably, a web is arranged between the seal and the sealing foot, and the web can have a spacing from at least one front face section. This ensures that the legs can bear against the seal on the respective front face section.

Embodiments of the invention are directed to a push fit coupling that includes a first element having a plug-in opening, a second element insertable into the plug-in opening, a retaining device surrounding at least one of the first and second elements; and at least one seal located on an inside of the retaining device. The first and second elements have front face sections facing towards one another, and the at least one seal is arranged between the front face sections.

In accordance with embodiments of the present invention, the at least one seal in cross-section can have two legs, and each legs can bear against a respective front face section. Further, a leak path may be formed by the leg bearing against the front face section of the first element and a circumferential area of the second element. Moreover, the leak path can be formed by the two legs with the circumferential area of the second element. A predetermined space can be maintained between the legs and the circumferential area, and the predetermined space may be maintained between radial ends of the legs oriented inwardly toward the circumferential area and the circumferential area.

According to another feature, at least one of the two legs may have an outside facing towards a respective front face section that is shaped to corresponds with the shape of the respective front face section.

In accordance with further embodiments, at least one of the two legs may have an essentially constant thickness.

In embodiments, the push fit coupling can further include a common base area from which the two legs start.

According other embodiments of the instant invention, at least one of the two legs can be curved.

Moreover, the retaining device can be embodied separately from the first element and from the second element.

According to still further embodiments, the seal can be connected to the retaining device in a fluidically sealed manner.

In accordance with further embodiments of the invention, the seal may be connected to the retaining device in a positive manner.

The seal can have a sealing foot, which surrounds the first element and the second element. Further, a web may be arranged between the seal and the sealing foot, so that the web is spaced from at least one front face section.

The invention is directed to a method of connecting two elements via a push fit coupling. The method includes inserting an insertable end of a first element into a receiving end of a second element, and axially pushing the first element relative to the second element so that a seal axially separates front face sections of the first and second elements.

According to embodiments of the invention, a retaining device can surround at least one of the first and second elements prior to the inserting and can surround both the first and second elements after the axial pushing of the first element relative to the second element. Further, the retaining device may include a stop to stop relative axial movement of the first element toward the second element when the front face sections contact the seal. Also, the seal may be connected to the retaining device, and the method can further include, after the inserting, maintaining a spacing between a radially inward end of the seal and the insertable end.

In accordance with still yet other embodiments of the present invention, the method can include channeling a fluid from an inside of the first and second elements to the seal axially separating the front face sections.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 illustrates a sectional view through a push fit coupling; and

FIG. 2 illustrates in detail sectional view II depicted in FIG. 1.

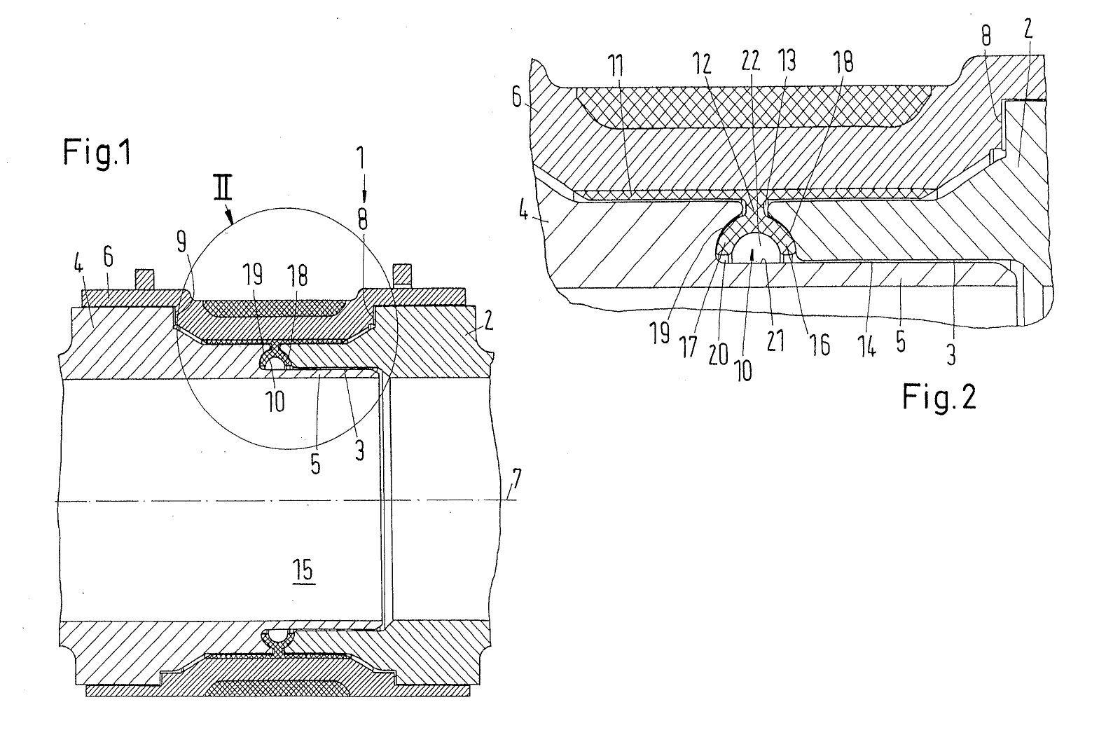

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

A push fit coupling 1 has a first element 2 with a plug-in opening 3 and a second element 4 with a support 5, which is inserted into plug-in opening 3. A retaining device 6 surrounds first element 2 and second element 4. Retaining device 6 is structured (not shown in further detail) to axially hold first element 2 and second element 4 in the position shown. When directional data, such as axial or radial, are mentioned below, these directional data are relative to an axis 7.

Retaining device 6 has a first stop 8, up to which first element 2 can be moved into retaining device 6, and a second stop 9, up to which second element 4 can be moved into retaining device 6.

A seal 10 is arranged radially inside retaining element 6. Seal 10 has a sealing foot 11, which is connected to retaining device 6. Sealing foot 11 can be adhered or welded to retaining element 6. Basically, any fluidically sealed connection is possible here. Seal 10 with sealing foot 11 can also be embodied in one piece with retaining device 6. For example, an identical elastomer can be used for retaining device 6 and seal 10, and the two elements can be cast jointly in an injection mold, in which an elastomer without hardener is used for seal 10.

Alternatively thereto, seal 10 with its sealing foot 11 can also be connected in a positive manner to retaining device 6. In this case, sealing foot 11 would be embodied somewhat shorter in the axial direction, and retaining device 6 can then have a groove in which sealing foot 11 is arranged.

Seal 10 is connected to sealing foot 11 via a web 12. Both elements 2 and 4 have a small spacing 13 from the web 12 in the axial direction. This spacing 13 is defined by the two stops 8 and 9.

As can be seen in particular from FIG. 2, a gap 14 is provided between support 5 and plug-in opening 3. Through gap 14, a fluid from interior 15 of second element 4 or of first element 2 can reach as far as seal 10.

Seal 10 has two legs 16 and 17, which start from web 12. Web 12 thus forms a common base area for the two legs 16 and 17.

First element 2 has a first front face section 18, and second element 4 has a second front face section 19. The two front face sections 18 and 19 lie opposite one another in the axial direction. Seal 10 is arranged between the two front face sections 18 and 19. When the two elements 2 and 4 are placed into retaining device 6, the two legs 16 and 17 bear against the two front face sections 18 and 19 with a slight preloading. Since the two legs 18 and 19 are attached to web 12 only on one side, they can be deformed slightly, no greater force being necessary for their deformation.

The two legs 16 and 17 have a spacing 20 from circumferential wall 21 of support 5 of second element 4. Accordingly, seal 10 with its two legs 16 and 17 does not bear against circumferential wall 21 of support 5. Accordingly, during the insertion of second element 4 into retaining element 6 or into first element 2, no frictional forces at all with respect to seal 10 are produced, which have to be overcome during assembly. The fitting forces therefore remain low.

Jointly with second element 4, and more precisely, support 5 of second element 4, the two legs 16 and 17 delimit a cavity 22 into which fluid can penetrate through gap 14. Spacing 20 thereby forms a deliberately embodied leak path, through which the fluid can penetrate into cavity 22. The pressure of the fluid in cavity 22 means that the two legs 16 and 17 are pressed against their front face sections 18 and 19. The greater the pressure in cavity 22, the greater too are the forces with which the two legs 16 and 17 are pressed against front face sections 18 and 19. The greater these forces, the better the seal tightness. It has been ascertained that a seal of this type is tight up to a pressure of 36 bar. Spacing 20 is shown in an oversized manner here. As a rule, it is sufficient to make it less than 1 mm so that the largest possible sealing length is produced.

The two front face sections 18 and 19 have a curvature embodied in a concave manner. The outsides of the two legs 16 and 17 have a correspondingly convex curvature. The curvatures of the outsides of the legs 16 and 17 and the curvatures of the front face sections 18 and 19 do not need to match one another exactly thereby. However, there should be a certain correspondence in order to render possible the largest possible bearing of the legs 16 and 17 against front face sections 18 and 19.

Legs 16 and 17 have an approximately constant thickness. Accordingly, they are also pressed largely uniformly against front face sections 18 and 19 by the pressure in cavity 22.

Instead of the curved embodiment, a straight-line or polygonal embodiment of legs 16 can also be selected. For example, the two legs 16 and 17 can also be arranged in a V-shaped manner with respect to one another or in the manner of a trapeze. However, it should be ensured in any case that legs 16 and 17 are pressed against front face sections 18 and 19 with sufficient force when pressure is applied to cavity 22.

It is shown that retaining device 6 is embodied separately from the two elements 2 and 4. However, it can also be firmly connected to one of the two elements 2 and 4. However, in this case the arrangement of seal 10 is somewhat more complex.

Seal 10 is shown only in section here. However, it is easy to see that seal 10 in the present exemplary embodiment is embodied as the radially outer half of a toroidal body.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A push fit coupling comprising:
a first element having a plug-in opening;
a second element insertable into the plug-in opening;
a retaining device surrounding at least one of the first and second elements; and
at least one seal located on an inside of the retaining device,
wherein the first and second elements have front face sections facing towards one another, and the at least one seal is arranged between the front face sections.

2. The push fit coupling in accordance with claim 1, wherein the at least one seal in cross-section has two legs, and each leg bears against a respective front face section.

3. The push fit coupling in accordance with claim 2, further comprising a leak path formed by the leg bearing against the front face section of the first element and a circumferential area of the second element.

4. The push fit coupling in accordance with claim 3, wherein the leak path is formed by the two legs with the circumferential area of the second element.

5. The push fit coupling in accordance with claim 4, wherein a predetermined space is maintained between the legs and the circumferential area.

6. The push fit coupling in accordance with claim 5, wherein the predetermined space is maintained between radial ends of the legs oriented inwardly toward the circumferential area and the circumferential area.

7. The push fit coupling in accordance with claim 2, wherein at least one of the two legs has an outside facing towards a respective front face section that is shaped to corresponds with the shape of the respective front face section.

8. The push fit coupling in accordance with claim 2, wherein at least one of the two legs has an essentially constant thickness.

9. The push fit coupling in accordance with claim 2, further comprising a common base area from which the two legs start.

10. The push fit coupling in accordance with claim 2, wherein at least one of the two legs is curved.

11. The push fit coupling in accordance with claim 1, wherein the retaining device is embodied separately from the first element and from the second element.

12. The push fit coupling in accordance with claim 1, wherein the seal is connected to the retaining device in a fluidically sealed manner.

13. The push fit coupling in accordance with claim 1, wherein the seal is connected to the retaining device in a positive manner.

14. The push fit coupling in accordance with claim 1, wherein the seal has a sealing foot, which surrounds the first element and the second element.

15. The push fit coupling in accordance with claim 14, further comprising a web arranged between the seal and the sealing foot, wherein the web is spaced from at least one front face section.

16. A method of connecting two elements via a push fit coupling, the method comprising:
inserting an insertable end of a first element into a receiving end of a second element;
axially pushing the first element relative to the second element so that a seal axially separates front face sections of the first and second elements.

17. The method in accordance with claim 16, wherein a retaining device surrounds at least one of the first and second elements prior to the inserting and surrounds both the first and second elements after the axial pushing of the first element relative to the second element.

18. The method in accordance with claim 17, wherein the retaining device includes a stop to stop relative axial movement of the first element toward the second element when the front face sections contact the seal.

19. The method in accordance with claim 17, wherein the seal is connected to the retaining device, and the method further comprises, after the inserting, maintaining a spacing between a radially inward end of the seal and the insertable end.

20. The method in accordance with claim 16, further comprising channeling a fluid from an inside of the first and second elements to the seal axially separating the front face sections.
